(19) United States
(12) Patent Application Publication
(10) Pub. No.: US 2017/0277979 A1
(43) Pub. Date: Sep. 28, 2017

(54) Identifying defect on specular surfaces

(71) Applicant: INOVISION SOFTWARE SOLUTIONS, INC., CHESTERFIELD, MI (US)

(72) Inventors: Jacob Nathaniel Allen, Richmond, MI (US); Brandon David See, West Bloomfield, MI (US); Patrick Kerry Krawec, Lafayette, CA (US)

(73) Assignee: INOVISION SOFTWARE SOLUTIONS, INC., CHESTERFIELD, MI (US)

(21) Appl. No.: 14/999,038

(22) Filed: Mar. 22, 2016

(51) Int. Cl. G06K 9/62; G06K 9/20; G06K 9/66

(52) U.S. Cl. CPC G06K 9/6269; G06K 9/66; G06K 9/6256; G06K 9/6292; G06K 9/2027; G06K 9/209

(57) ABSTRACT

A light is shined on a specular surface of an inspected object at a fixed position. Light is reflected directly from the surface into a fixed camera. Multiple images are taken as the light source moves. Images are fused into a single image. This invention takes a single image and generates several defect detection images using several distinct image processing sequences. Each defect detection image alone could be used to identify when defects are located under a camera pixel, but the several images are combined to create a feature vector that can be used as an input to a pattern classifier. The pattern classifier may be trained to achieve superior defect detection results by combining several detection images.

### BACKGROUND OF THE INVENTION

1. Field of the Invention

A method for identifying defects on specular surfaces including, positioning an inspected object at a predetermined inspection location, positioning an inspection camera at a fixed camera location, moving a light source along a light source path consisting of a plurality of light source locations, acquiring a plurality of inspection snap images from the inspection camera when the light source is located at the light source locations, creating a fused inspection image by combining the inspection snap images; and identifying surface defects in the fused inspection image.

2. Description of the Prior Art

Specular surface inspection systems that capture images of light reflecting directly from a specular surface are known. The images are inspected for defects using image processing techniques such as blurring, alignment, masking, and thresholding. These systems signals use the output of a single image processing sequence to determine when a defect is located under a pixel.

### SUMMARY OF THE INVENTION

This invention takes a single image and generates several defect detection images using several distinct image processing sequences. Each defect detection image alone could be used to identify when defects are located under a camera pixel, but the several images are combined to create a feature vector that can be used as an input to a pattern classifier. The pattern classifier may be trained to achieve superior defect detection results by combining several detection images.

### ADVANTAGES OF THE INVENTION

The invention allows several defect detection signals to be split from an image and recombined as the feature vector input to a pattern classifier. This results in fewer false positive errors and fewer false negative errors during defect classification. Better defect classification results save on the costs spent dealing with false positives, improve overall quality, and improve the confidence that can be placed in defect reports.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1: Flow of Method

FIG. 2: Inspection station

FIG. 3: Supplemental information

FIG. 4: Calibrating the camera position.

FIG. 5: Masking off regions of the three dimensional surface to ignore.

FIG. 6: The final result after masking off image.

FIG. 7: A three dimensional simulator to calculate surface values in three dimensional world space.

FIG. 8: A three dimensional simulator to display camera views, positions, and orientations.

FIG. 9: Single images (top) are fused together (bottom) to show surfaces covered by a camera in pink.

FIG. 10: A simulation movie is created from all generated frames to show surface coverage and possible obstructions as the portico moves.

FIG. 11: Surface area coverage is represented by a heat map. Red represents the best coverage.

FIG. 12: Camera coverage values are combined into a single image. A blue surface is covered by a camera view.

FIG. 13: Setting up a real world scene to verify three dimensional world space accuracy.

FIG. 14: The lab is being set up to calibrate against the color palette.

FIG. 15: Testing simulated light reflections values against a real world image to verify simulated reflection accuracy.

FIG. 16: A GigE camera driver interface was developed to control the camera.

FIG. 17: Light values are smoothed in captured images.

FIG. 18: Patterns are found in images and matched against coordinates in a master image for alignment.

FIG. 19: Algorithms are applied to highlight and detects defects on the vehicle surface.

FIG. 20: A closer view of the detected defect.

FIG. 21: Bayer images are converted to color and filtered for color.

FIG. 22: An algorithm testing framework to allow for fast testing of algorithms on images.

FIG. 23: Color plates are used to calibrate the camera and accurately detect colors.

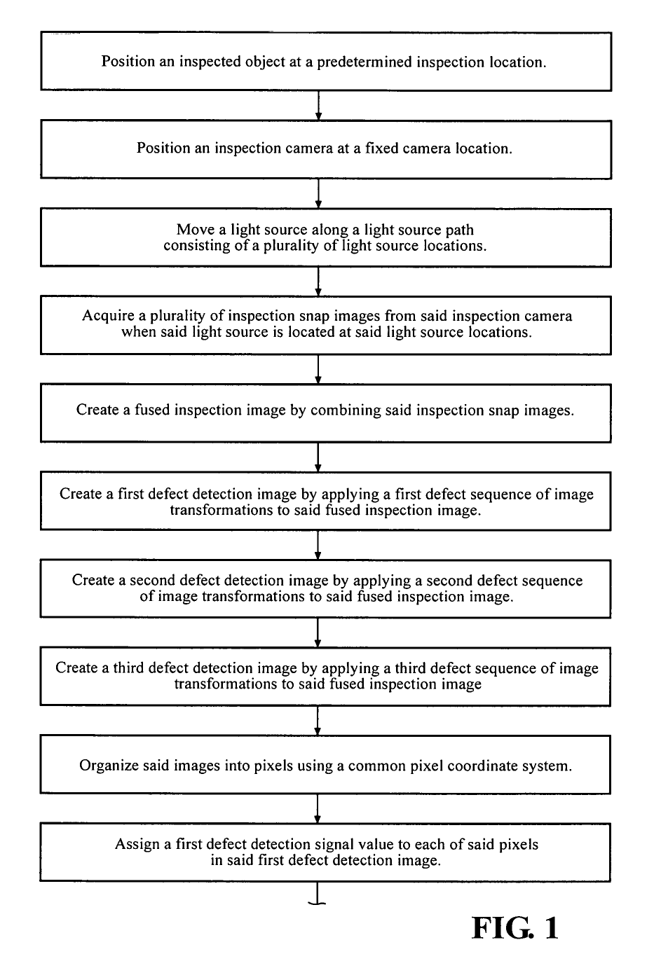

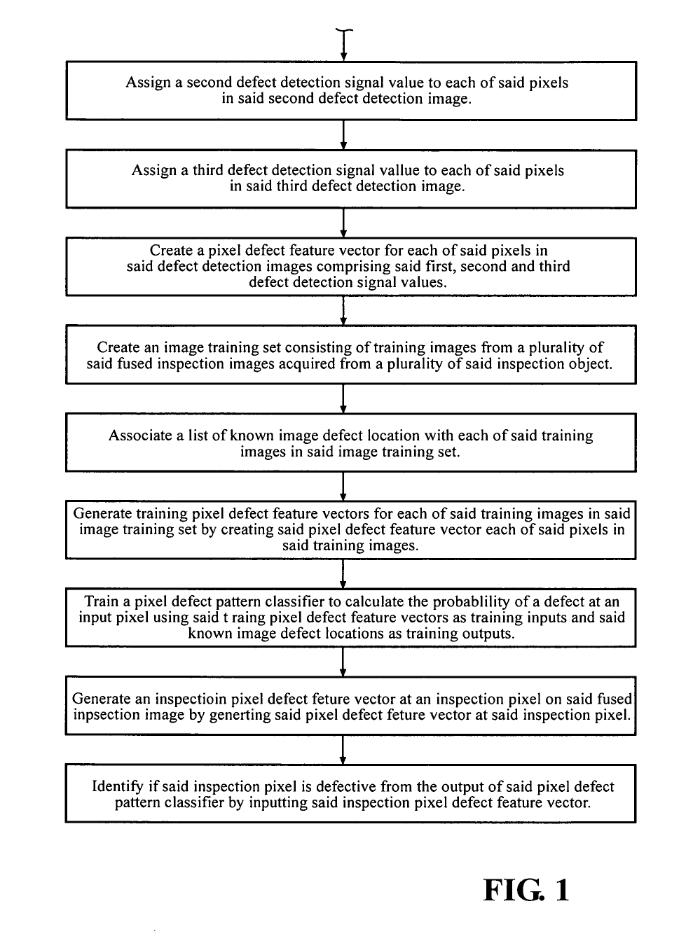

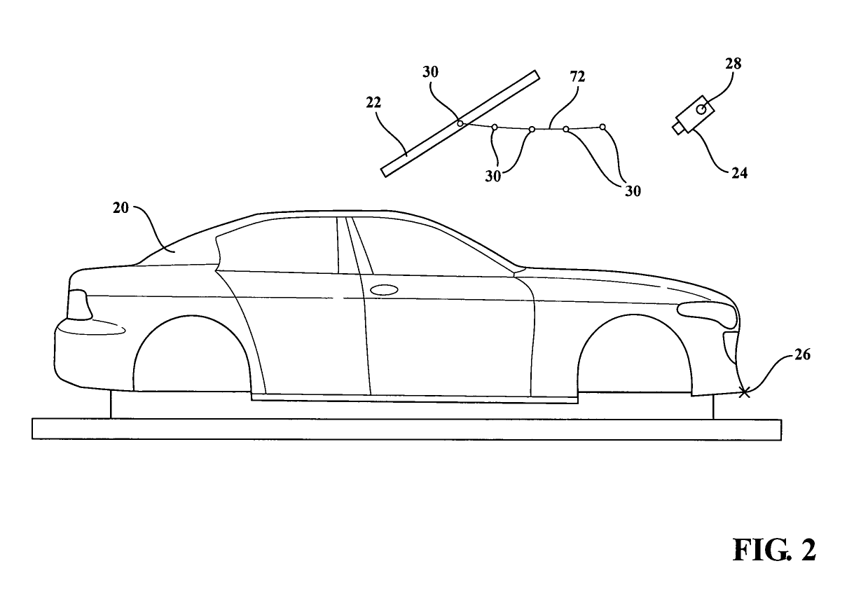

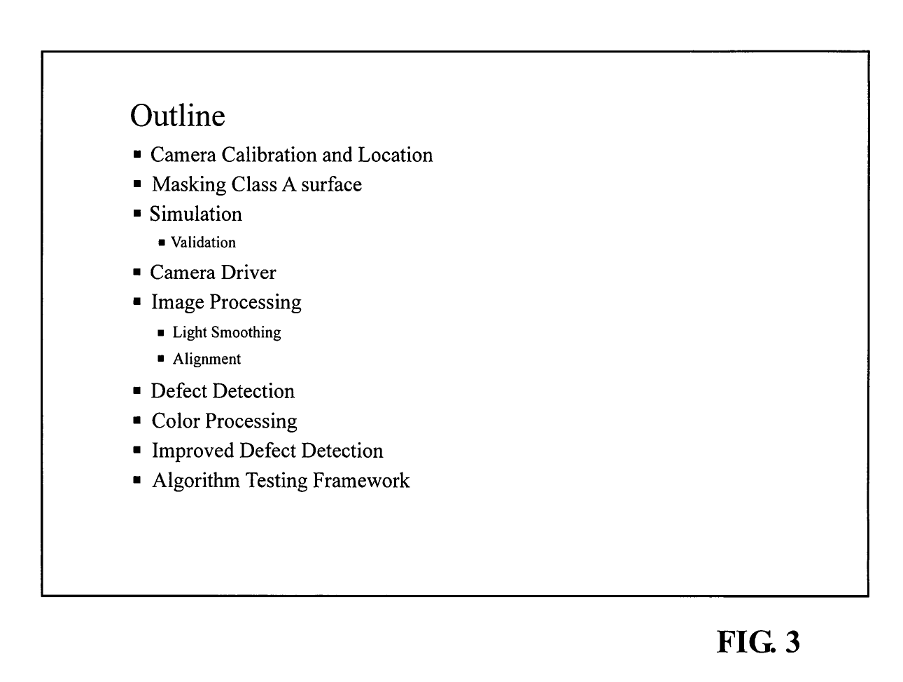

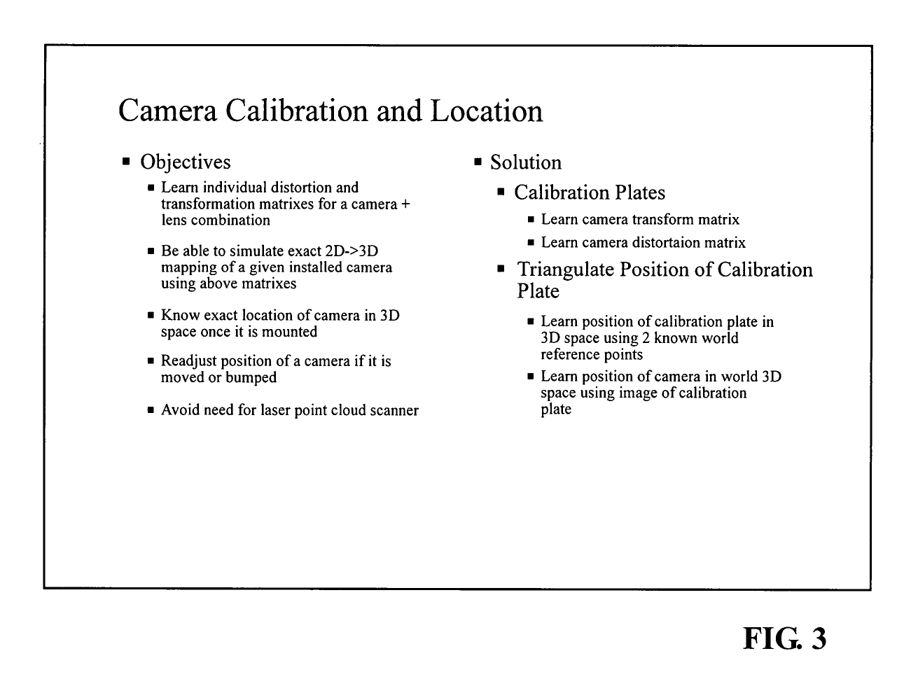

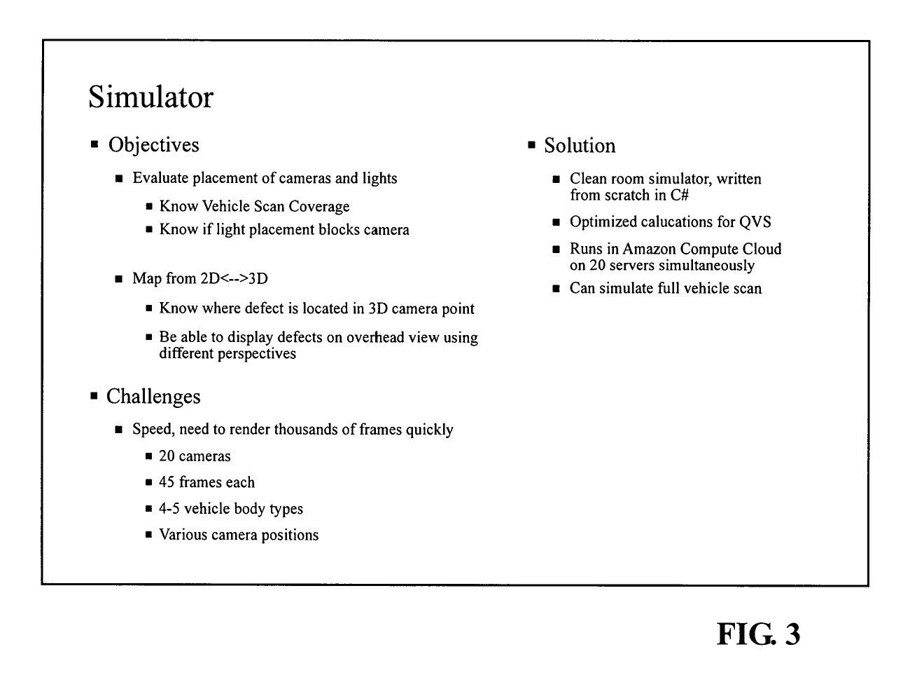

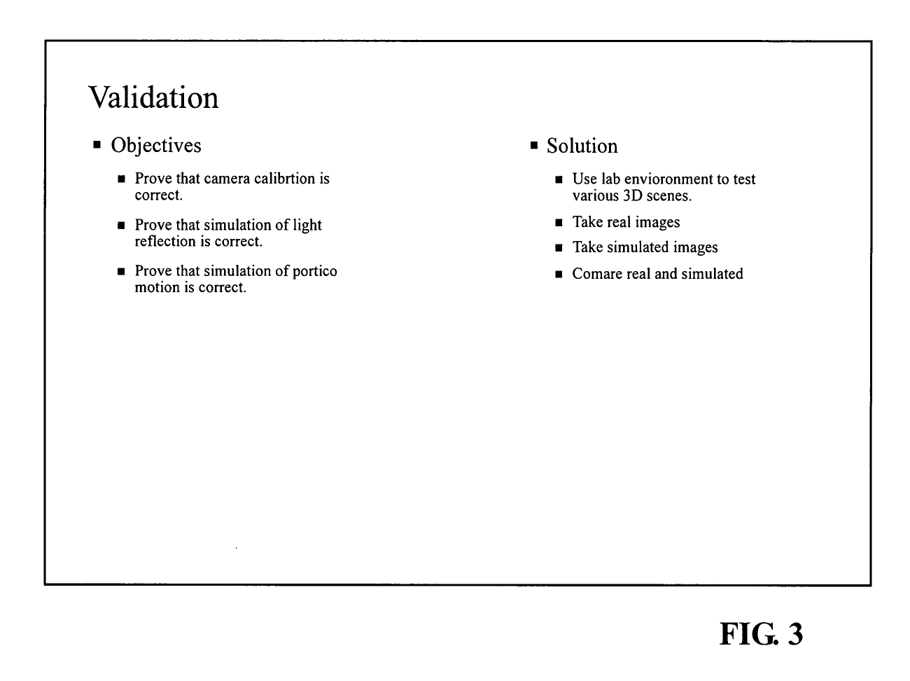

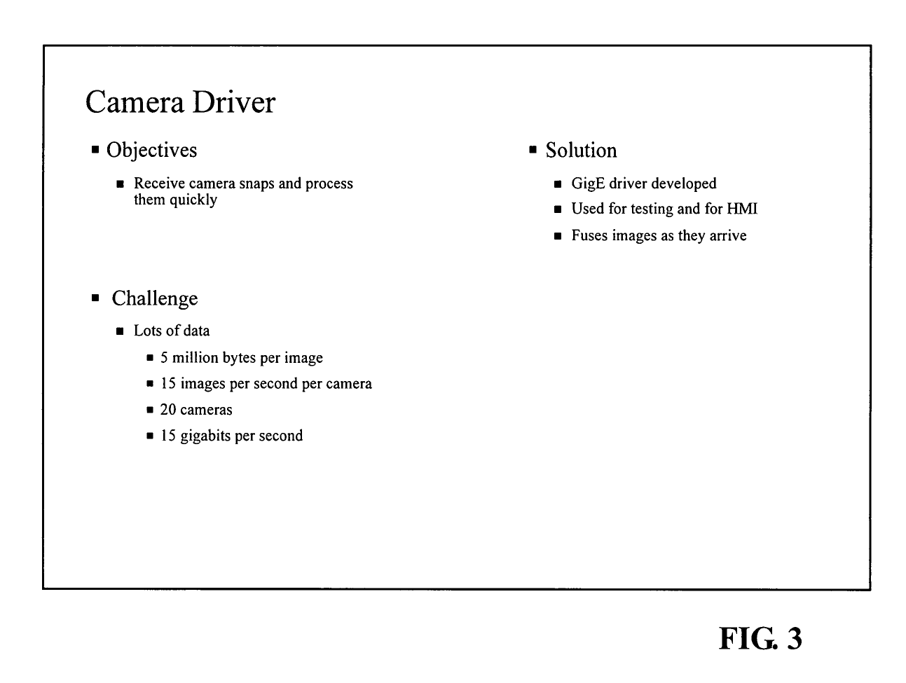

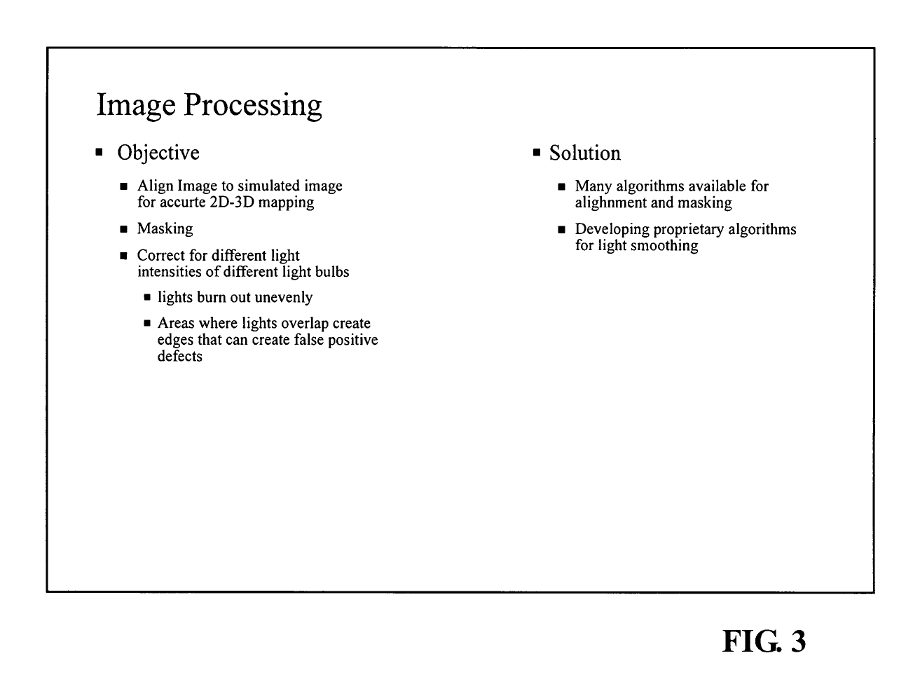

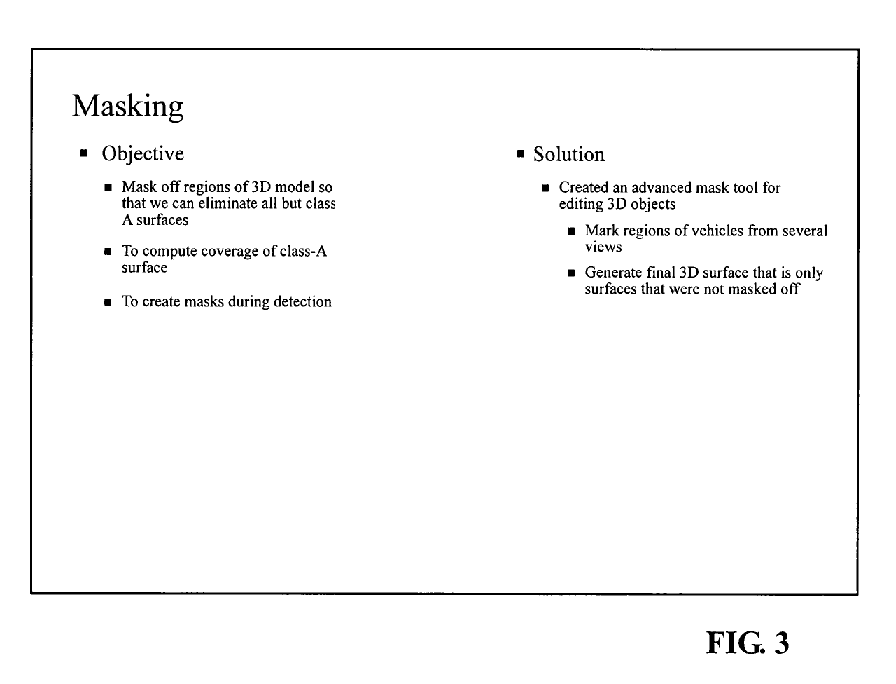

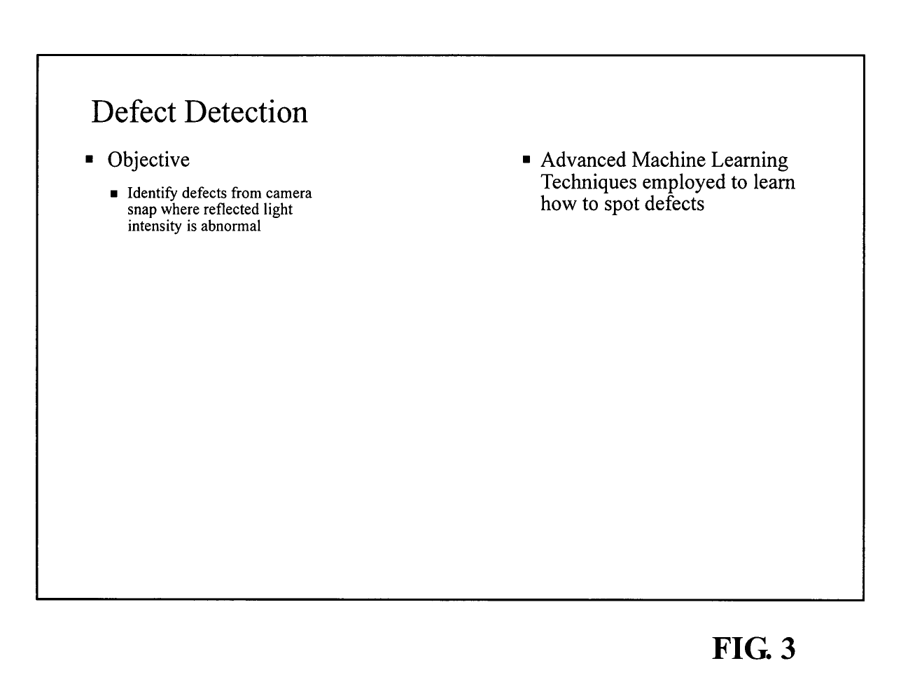

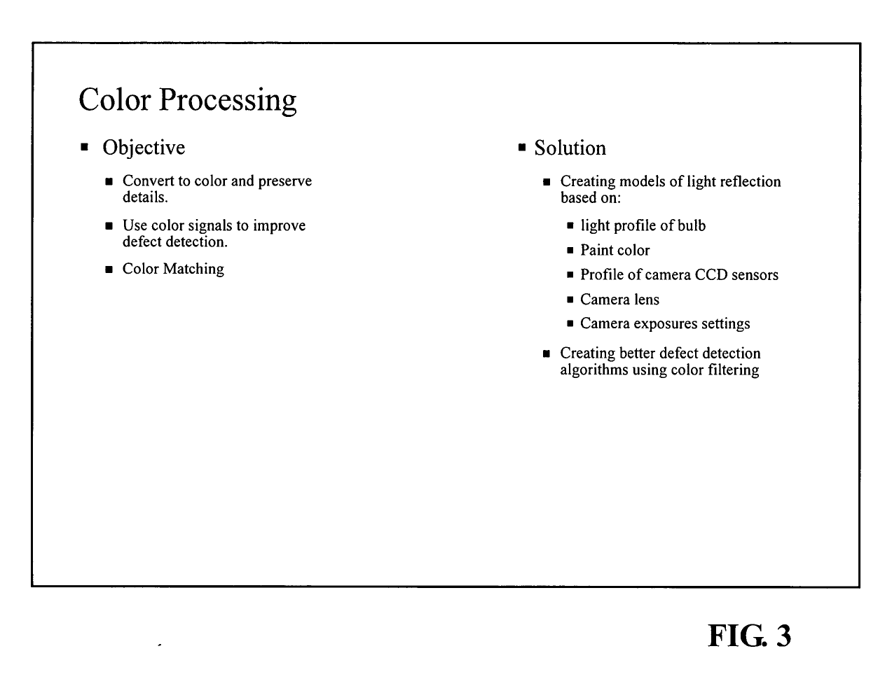

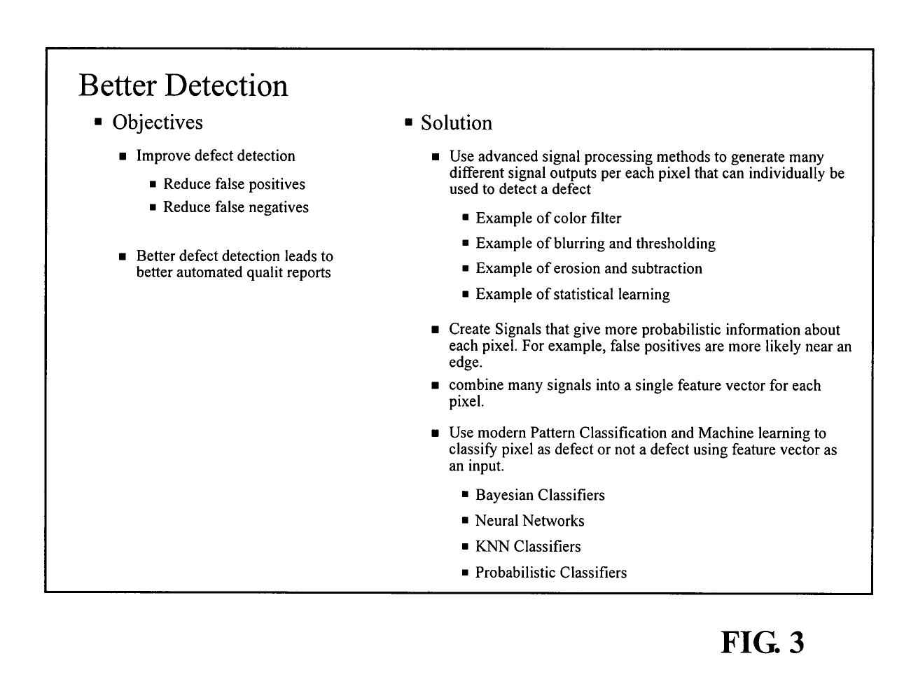

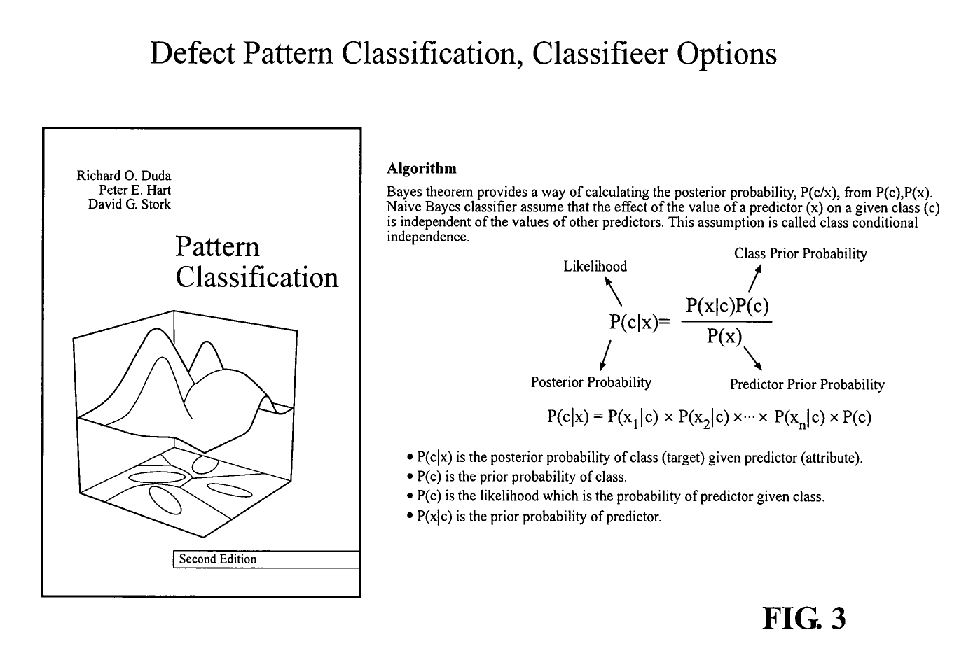

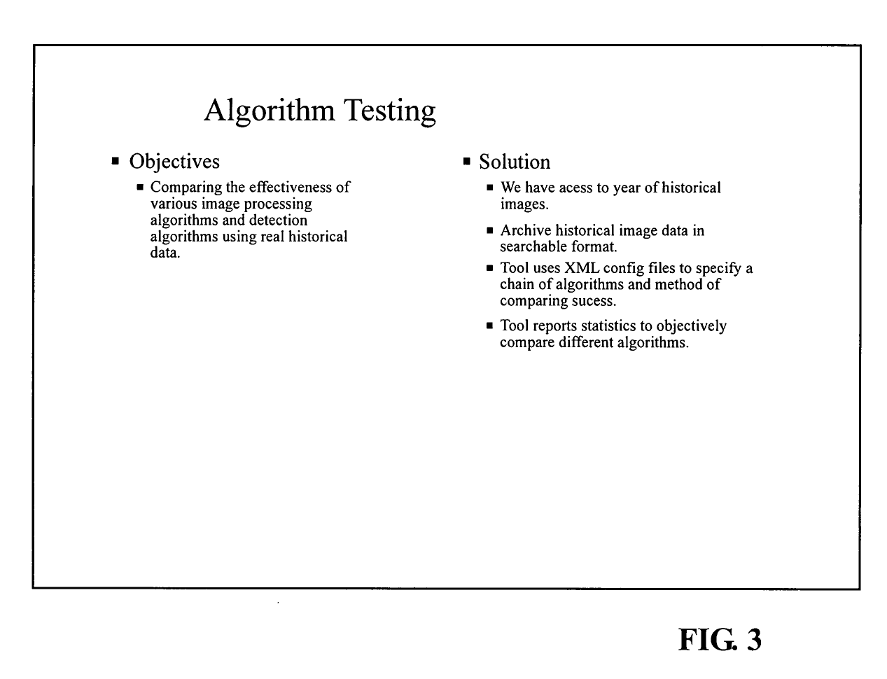

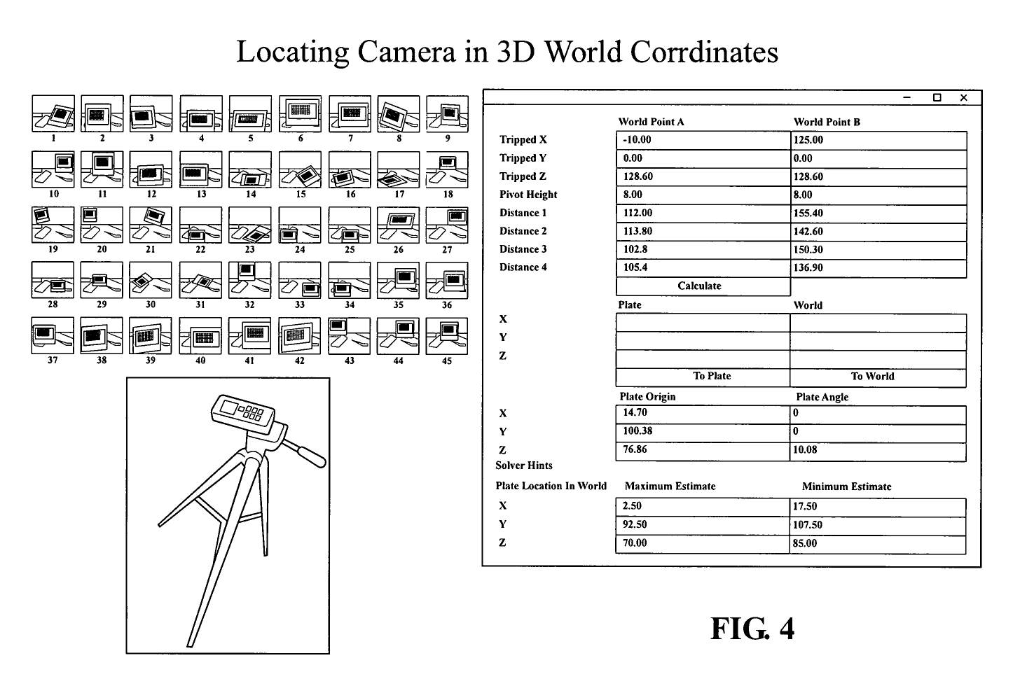

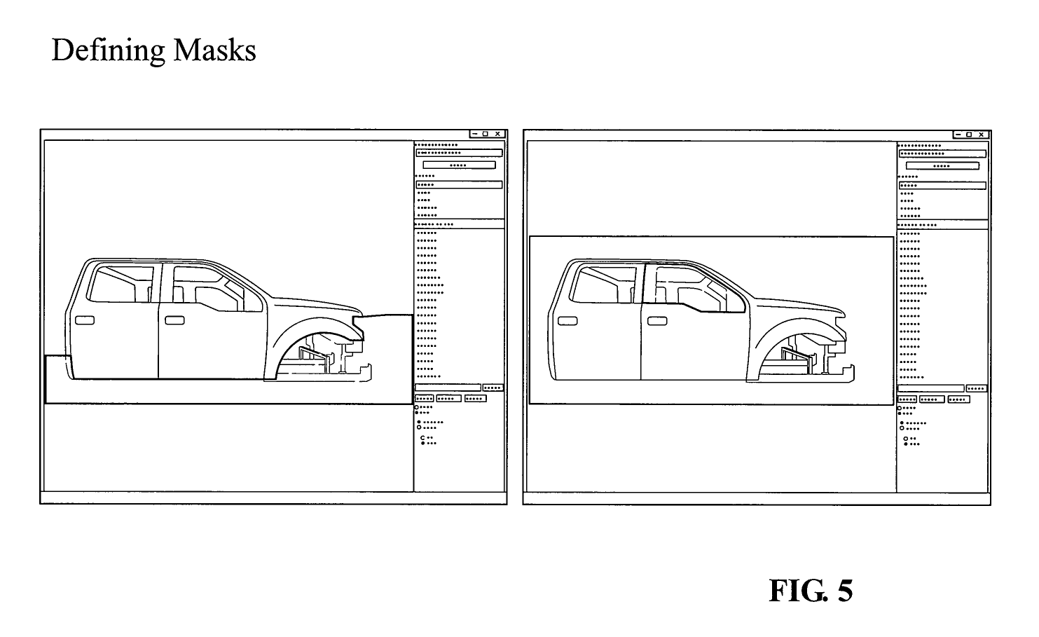

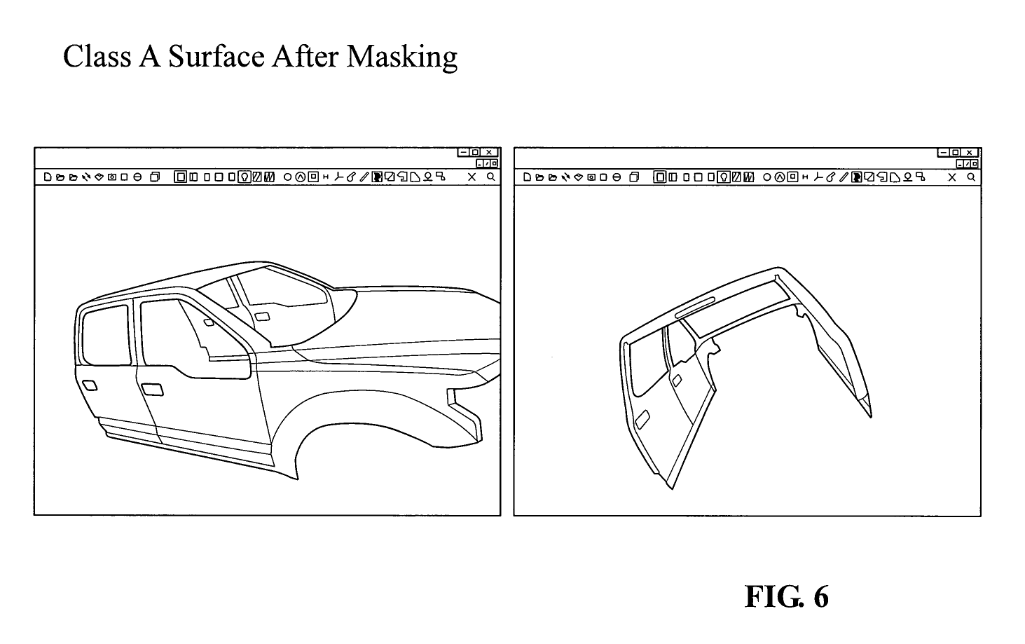

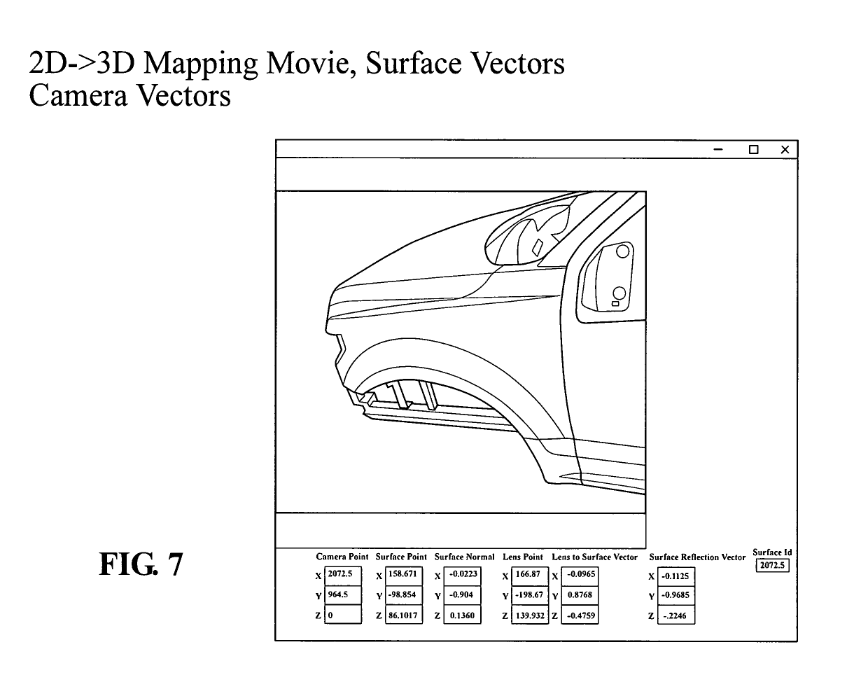

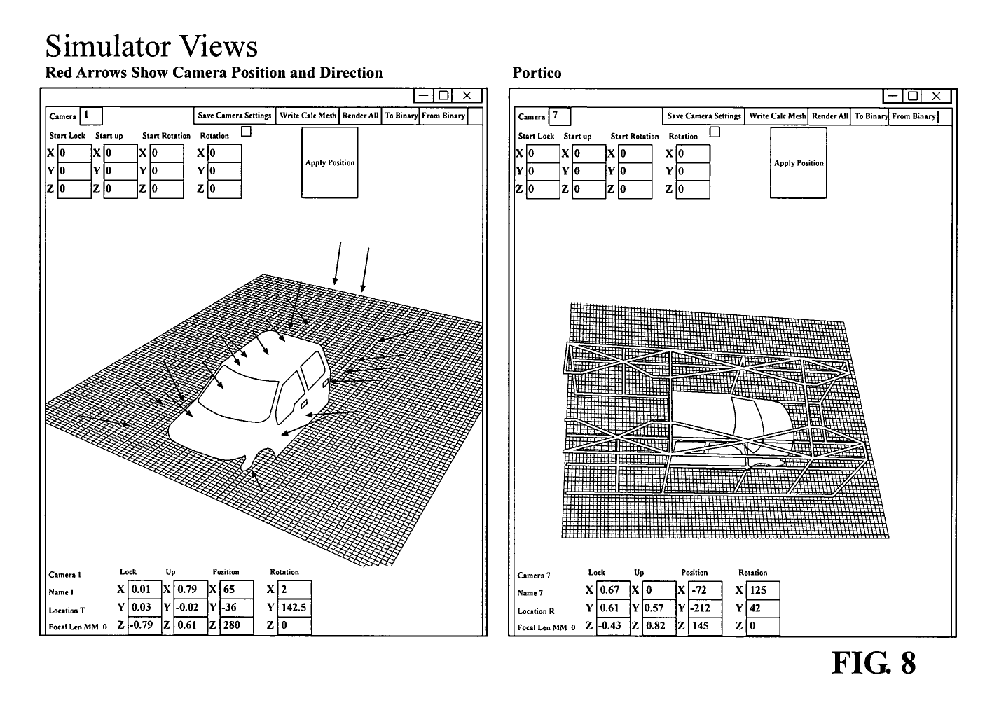

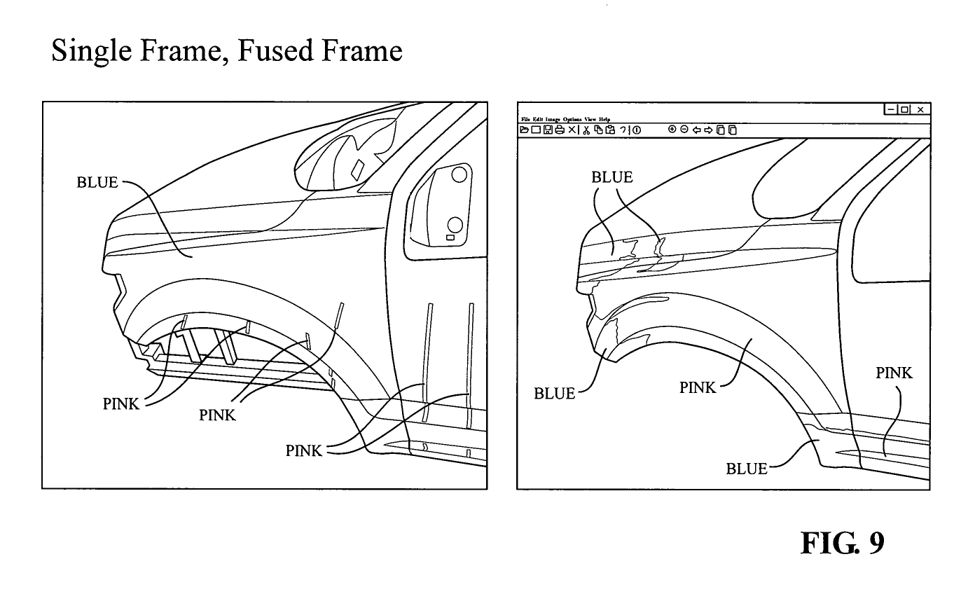

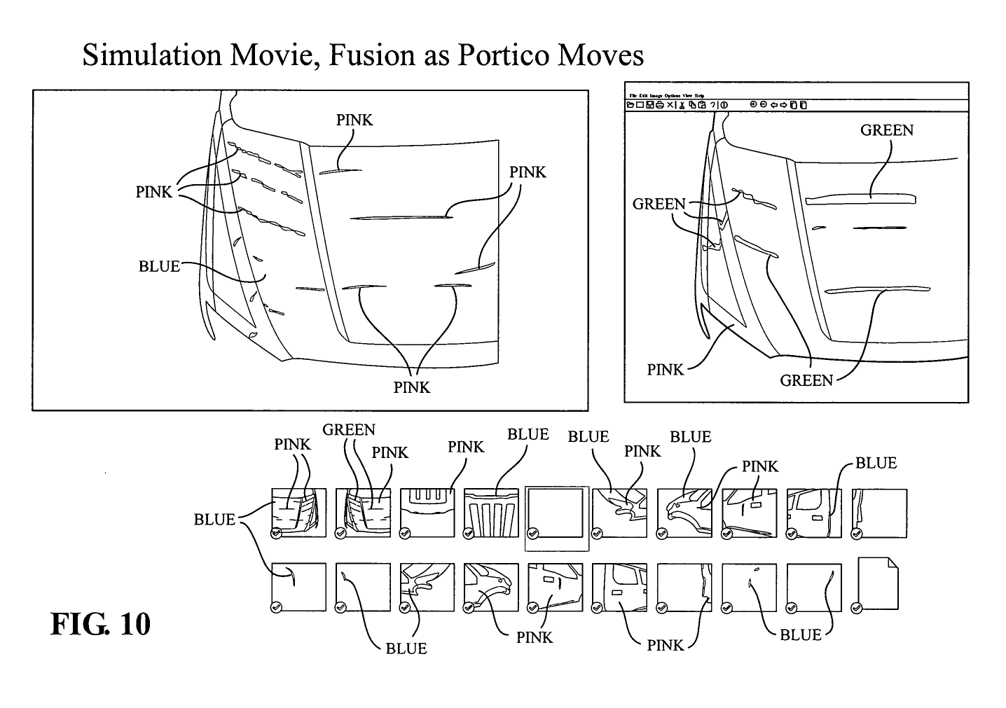

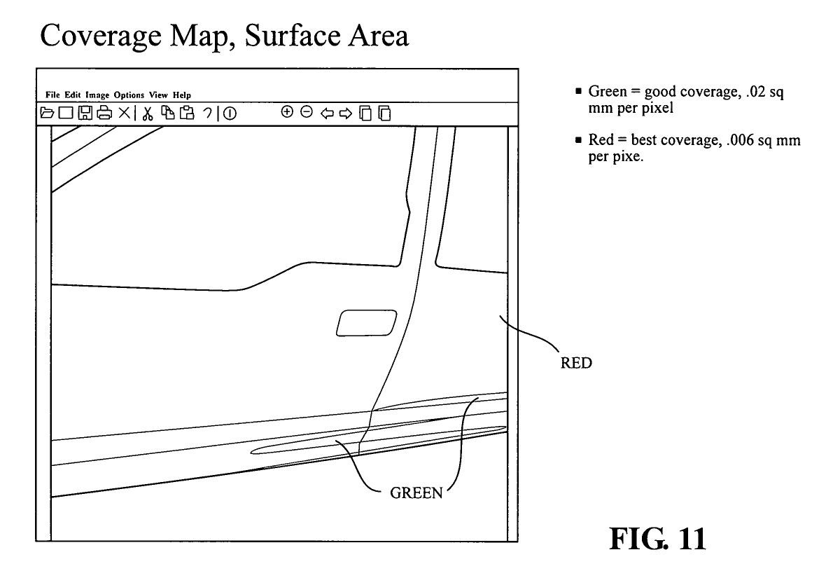

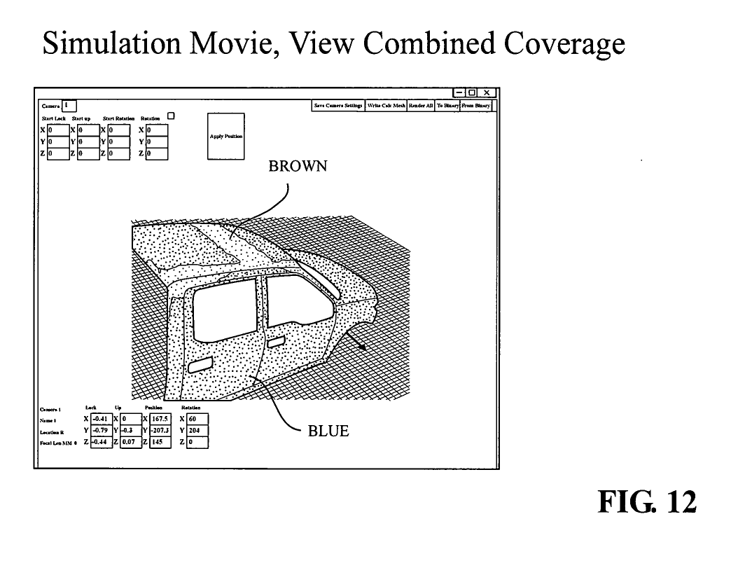

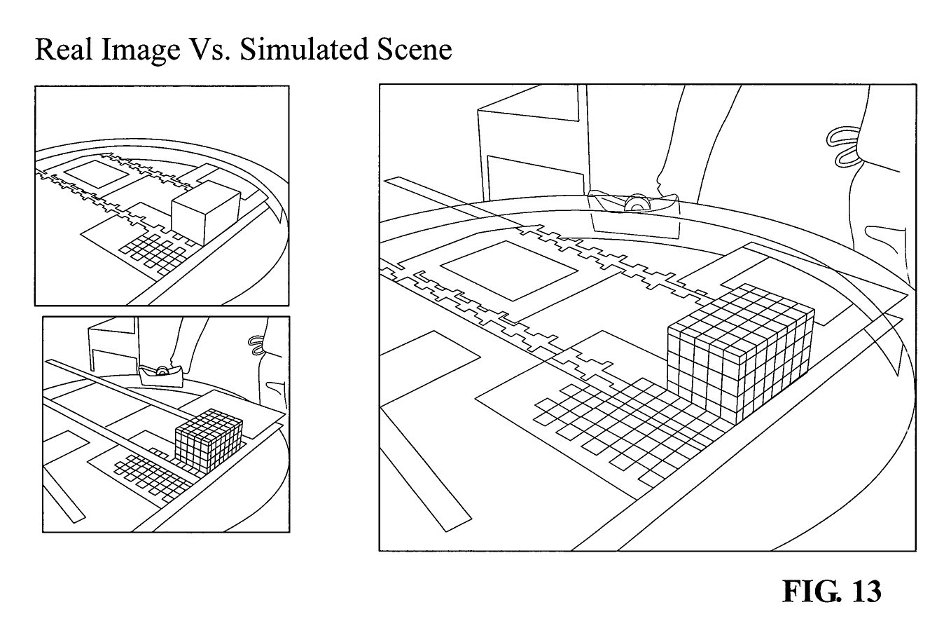

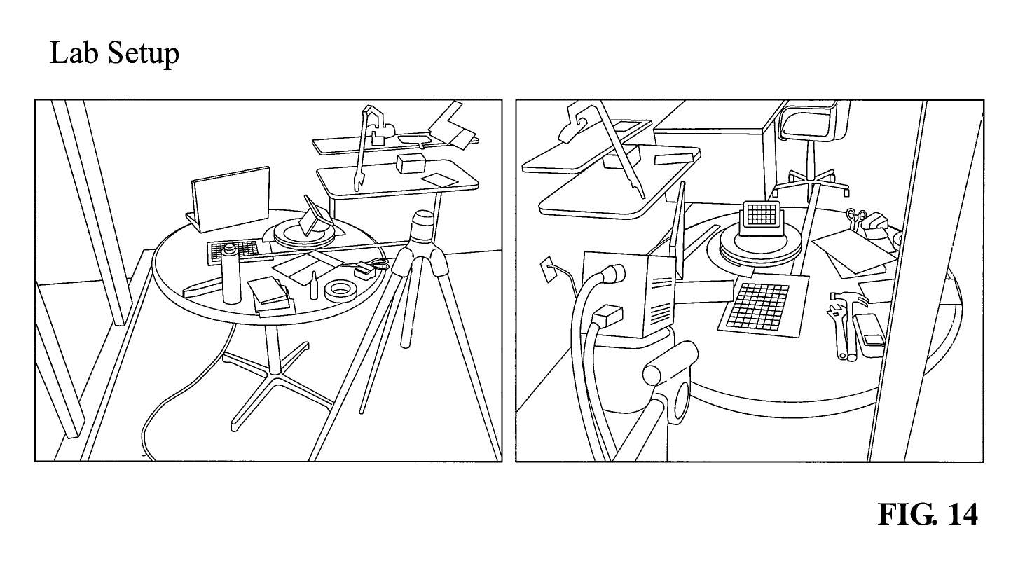

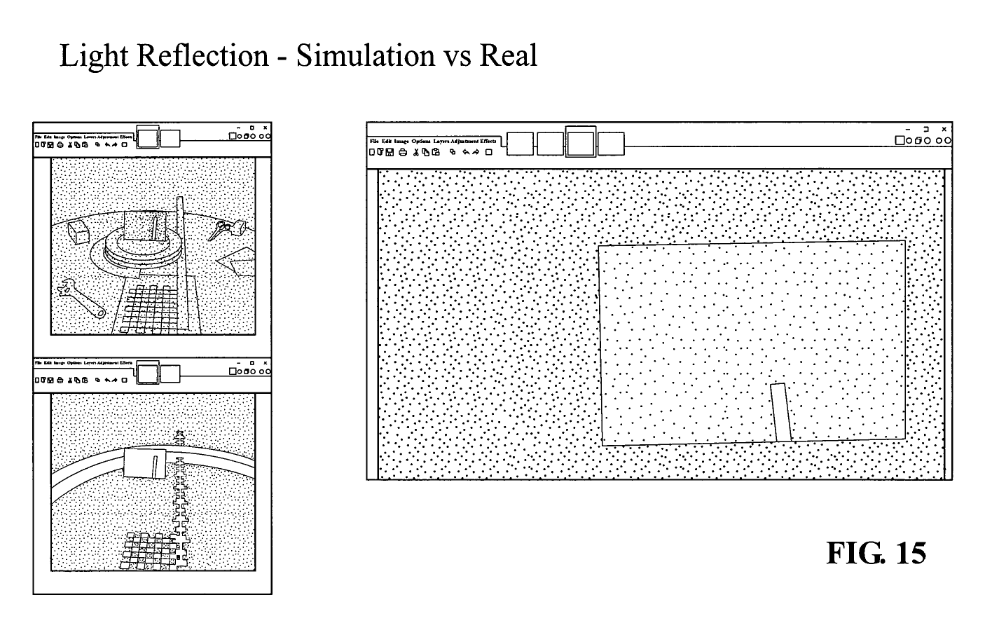

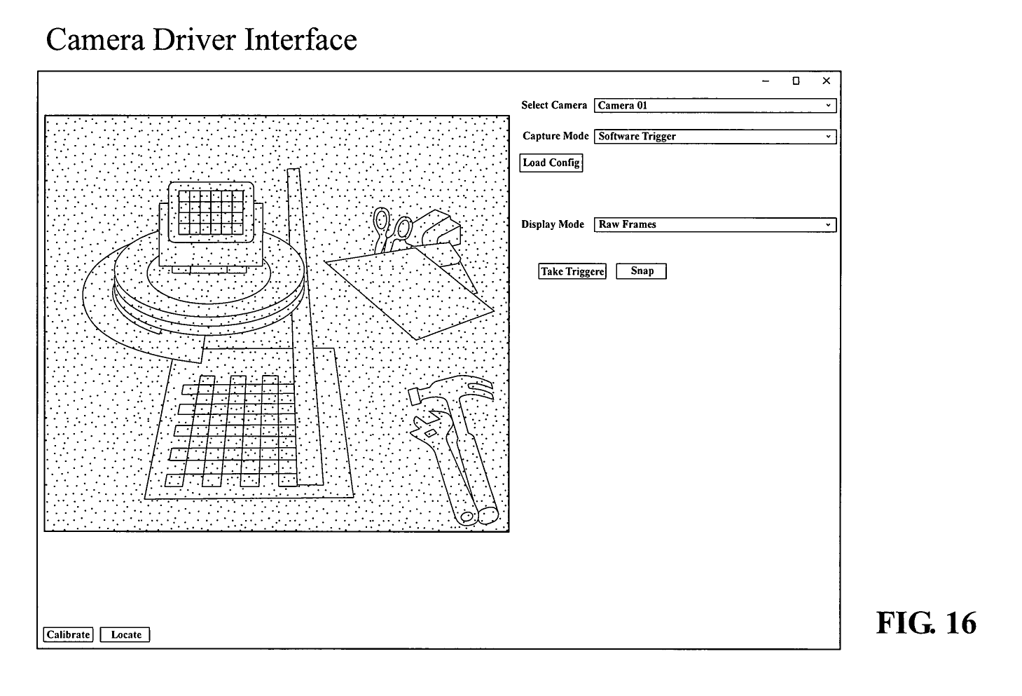

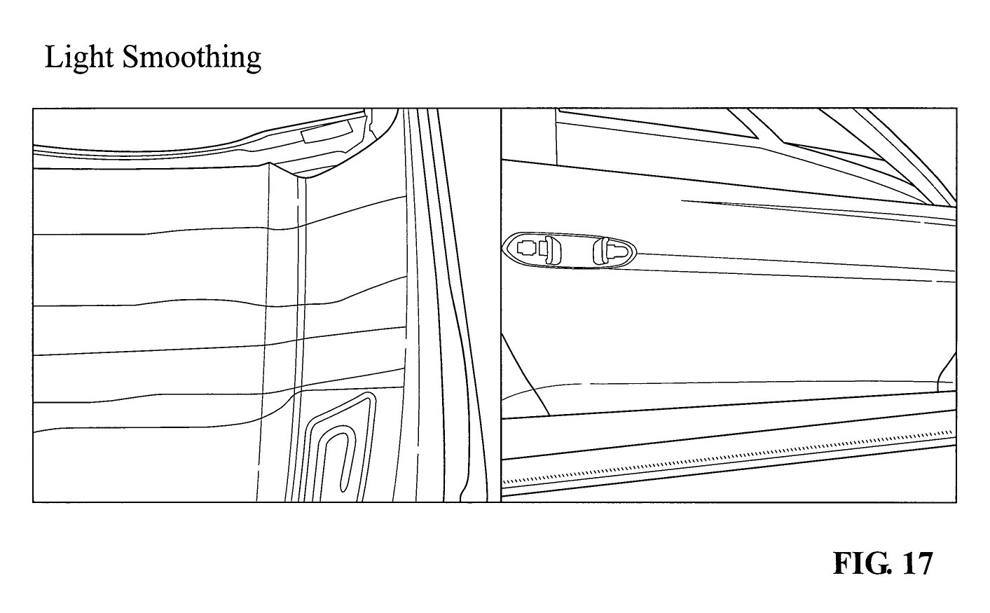

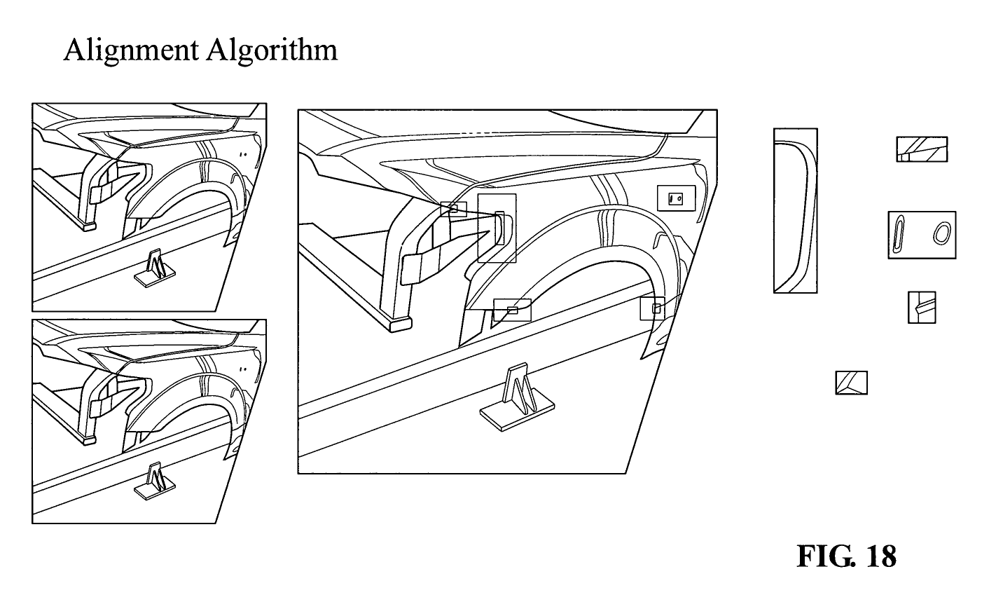

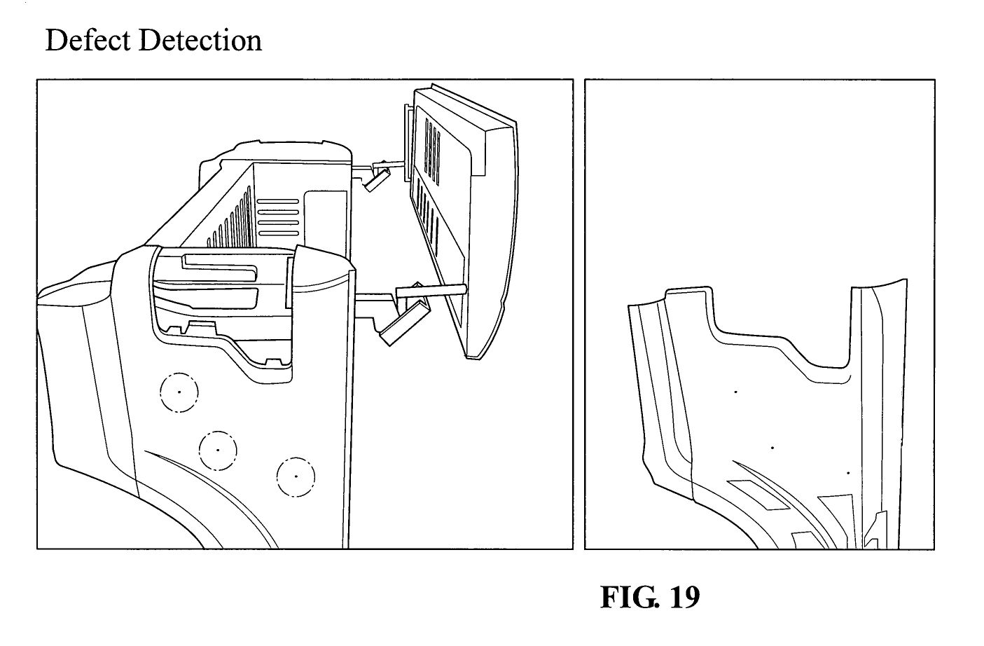

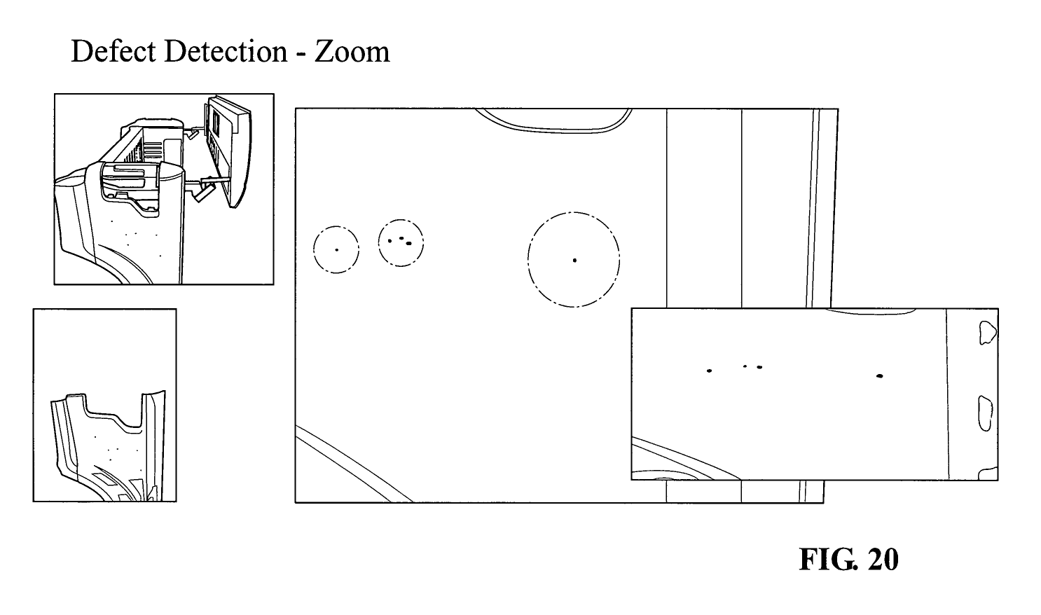

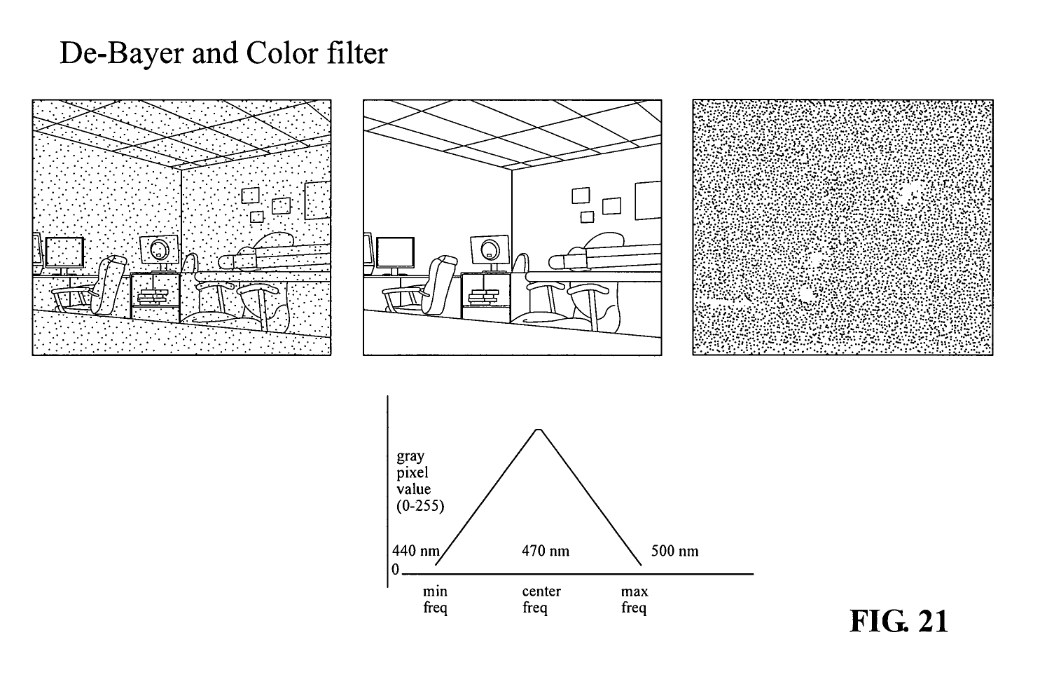

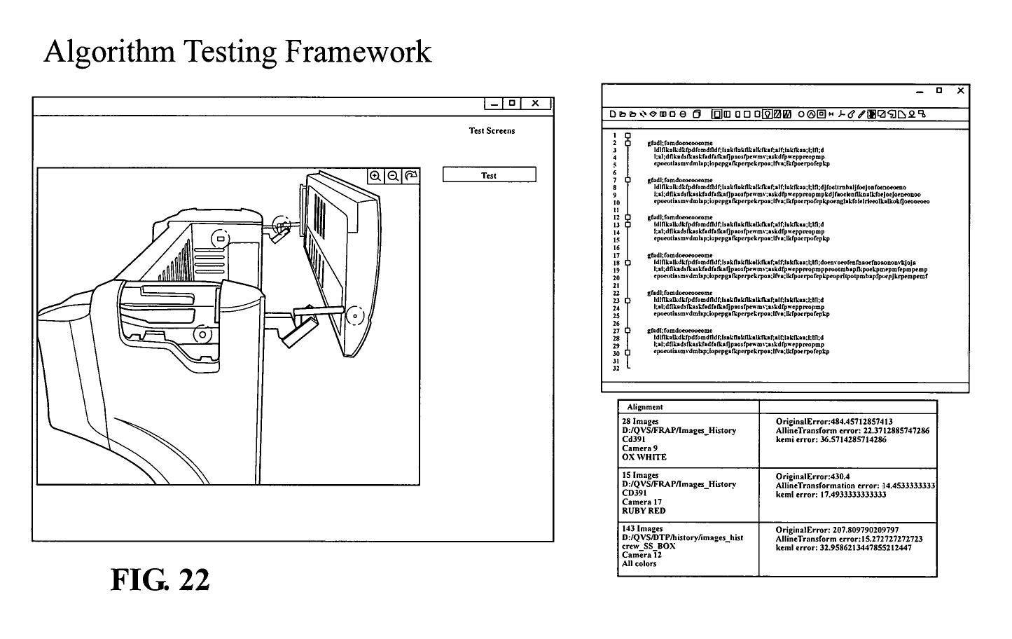

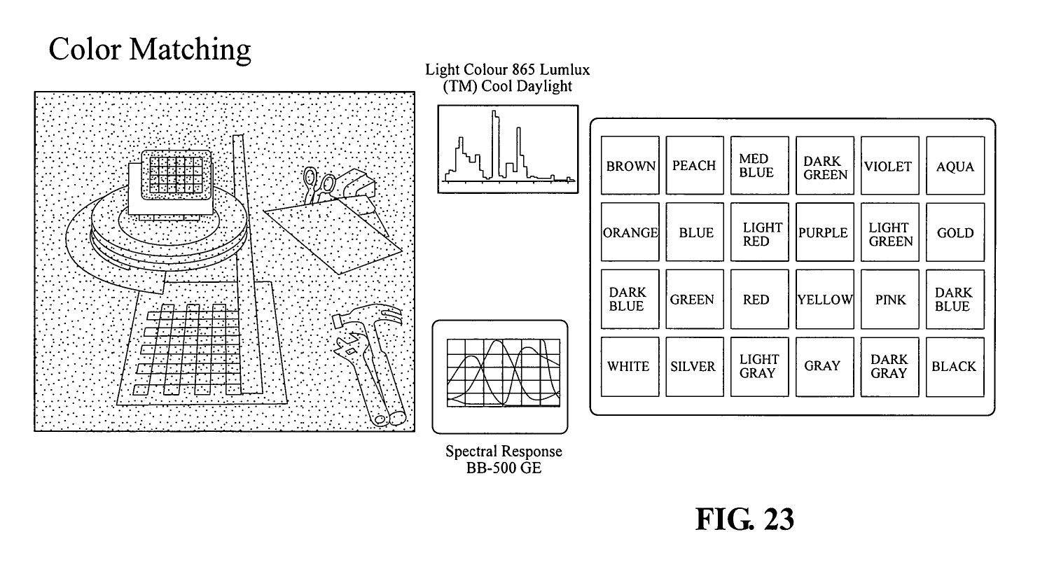

### DESCRIPTION OF THE ENABLING EMBODIMENT

Referring to the Figures, wherein like numerals indicate corresponding parts throughout the several views, a method for identifying defects on specular surfaces is described.

The inspected object has a specular surface that reflects light. In one embodiment of this invention, the object being inspected is a painted automobile body. Defective areas in the specular surface will reflect light differently than non-defective areas, so defects will typically appear as dark spots on the specular surface within the reflected image of a light source shining on the object. To facilitate automated inspection, an inspection camera takes an image of the light source reflected on a surface.

It is desirable to relate the two dimensional coordinate position of a defect found in a camera image to the three dimensional location of the object being inspected. Vibration and motion interfere with consistent mapping from two dimensional camera coordinates to the three dimensional vehicle surface location, so both the camera and the vehicle body are fixed in a repeatable inspection position and location as much as possible, however there are still some small location variations due to vibrations, positioning errors, and variations in the surface of the inspected object. Often the inspected object arrives on a carrier, and the carrier is mechanically positioned which leads to small variations in an inspected object's position.

The light source is one or more lights which may move independently or together, and typically the light sources are fluorescent light tubes that mounted on a moving light structure referred to as a portico. During the inspection process, the light structure moves so that the light will be reflected at different locations on the inspected object. The lights move along a programmed path, or along at track, both referred to as a light source path. The camera takes an inspection snap image when the light source is at a specified light source location. The light source will move to other light source locations and additional inspection camera snaps will be taken. The path of the light source is such that it will be at a specified light source location when a given inspection snap is taken. Typically, during the course of a single inspection, the light moves to many locations and the camera takes many inspection snap images.

The inspection snap images are usually captured using a digital camera resulting in a digital image having pixels that may be in a greyscale, raw Bayer color format, or color RGB format. The pixels usually represent the intensity of light captured, by the camera the given pixel location, but may also be converted from a raw format by the camera to a common digital image file format. There is a common pixel coordinate system for images, where an individual pixel on the image may be identified by a coordinate.

During the inspection process, many images may be taken. For example, the portico light structure may move on a track in motion so that light sources sweep over the vehicle and images are captured at a rate of more than frames per second. A set of inspection snap images will be combined to create a single fused inspection image. Typically, the fused inspection image is created by applying a max operation to the inspection snap images, pixel by pixel, but any algorithm that combines the pixels at a coordinate into one pixel is sufficient. In other words, a pixel identified by pixel coordinate is selected. Each pixel at this pixel coordinate location is examined across the set of all of the inspection snap images and the maximum value will be selected. So for example, the pixels at coordinate) will be selected for all of the inspection snap images and the maximum value of these pixels will become the final value for the pixel in the fused inspection image at coordinate). The same method is applied to set the final pixel value in the fused inspection image at coordinate) and so forth for all pixel coordinates. The resulting fused inspection image is a composite image that reports the highest intensity of light reflected at each camera pixel coordinate during the scanning process.

The fused inspection image is then processed by a series of image processing algorithms or image transforms to eventually produce a defect detection image. The defect detection image is a final image where each pixel coordinate has a pixel value indicating a defect detection signal value. The defect detection signal value communicates when a defect is identified on the inspected object at a pixel coordinate. For example, a defect detection image may have pixels with defect detection signal values of zero or not-zero, in which case the value of zero would indicate that no defect was located at the image location and a not-zero value would indicate that defect was located at the image location. However, the defect detection signal values at the pixel locations are not constrained to be zero or not-zero. Defect detection signal values could also be floating point numbers represent a probability of a defect being at the pixel location. Or, defect detection signal value could represent a statistical correlation value to relate that a defect may be present at a location. A key advantage of this invention arises from the principle that the exact meaning and the exact probability and the exact correlation of defect detection signal values at a pixel in the defect detection image do not need to be known in order for the final defect classification to be successful, although the invention works best when there is a strong correlation between the value of a defect detection image pixel's defect detection signal value and the presence of a real defect on the surface recorded at the image pixel location.

It should also be noted that detection algorithms might simply produce a list pixel coordinates where a defect is located, with associated values to correlate that a defect may be at that location. This type of list is considered a defect detection image, because it necessarily implies that all the pixels not in the list should be considered as if they do not have a defect, and the listed pixels would have a defect detection signal value indicating that there is a defect at the pixel location.

The defect detection image is produced by a series of image transformations. Image transformations input an image and a set of transformation parameters, and then output a transformation image. Many image transformations are well known, including but not limited to rotation, translation, matching, blurring, scaling, shifting, sharpening, edgedetection, brightening, color transform, erosion, dilation, and masking. Images may be transformed in other domains, including the spectral domain, luminosity, color, or the wavelet domain. Images may be transformed using neural networks or adaptive filtering. There are many well-known image processing algorithms and toolboxes available to the user of this invention and they are not all listed here. The output transformation image may include all points in an image, or it may include a subset list of coordinates points from an image. The size and coordinate system of the output image may not always be the same as the size and coordinate system used by the input image, but it will be possible to map a coordinate from the transformed image back to the original fused inspection image.

A sequence of defect image transformations will be selected and adjusted to configure the invention in order to suit the conditions of a particular inspected object and the light lighting conditions and the surface. Several possible image transformation sequences that are useful for vehicle paint inspection are now described. A fused inspection image may first be passed through a class of blurring image processing algorithms to smooth the edges of light sources on the image. A Gaussian blur is one example of a blurring algorithm. Then the blurred image may be passed through an alignment image transformation so that the output image is affine transformed to match a reference image in a way that improves the mapping of two dimensional image coordinates to a three dimensional surface coordinate. Next, the aligned output image is passed through a mask algorithm image transformation that converts pixels to zero if they are known to be pixels that do not capture some surface of the inspected object. Edges or trouble areas may also be masked. Then, the output masked image may be passed through a threshold image transform, so that pixel values above a given threshold are converted to a maximum value, and pixel values above a given threshold are unchanged. The final image produced by this example sequence of defect image transformations as applied to a fused inspection image produces just one possible example of a defect detection image because the value of a pixel in the example defect detection image will be negatively correlated with presence of a defect at that location.

Just as there are many variations of possible image transformations, there are many ways to combine them to configure a sequence of image processing algorithms that will create a defect detection image. For example, the parameters of a Gaussian blur algorithm may be modified to produce a different defect detection image from the example above. The image may be inverted. The threshold may be changed.

In one embodiment, the sequence of defect image transformations includes an image transformation using color, for example, a Bayer encoded image may be transformed into an RGB color image and then a hue filter may be applied. The parameter for the hue filter may be tuned to match the learned expected hue of a vehicle under inspection. Alternatively, the transformation algorithm might selectively modify the intensity of pixels having a hue that is different from surrounding pixels. Both methods are advantageous for highlighting defects on spectral surfaces and can be used as part of a sequence of defect image transformations to produce a defect detection image.

Previous systems for identifying defects on spectral surfaces identified defects on images using a single defect detection image, which is effectively identifying a defect using just one or two defect detection signal values. This system intelligently combines many signals from many defect detection images to create a final and superior defect determination at a pixel. For this method of defect detection, at least three different defect image transformations are selected to create pixel defect feature vectors. This method combines many defect detection signal wines into a pixel defect feature vector to produce a superior final result than would be achieved using just one or two defect detection signal values alone.

Accordingly, a first defect detection image is created by applying a first sequence of defect image transformations to the fused inspection image, a second defect detection image is created by applying a second sequence of defect image transformations to the fused inspection image, and a third defect detection image is created by applying a third sequence of defect image transformations to the fused inspection image. Even more than three defect image transformations may be used to produce additional defect detection images and more defect image transformations will improve the results. It is important for the defect image transformations to be different from one another.

The defect detection signal value from the several defect detection images are then combined for pixels sharing common coordinates to produce a pixel defect feature vector for each pixel. So, for a given pixel coordinate, there will be a pixel defect feature vector having an ordered set of element values taken from the set of defect detection images. For example, the value of element in the pixel defect feature vector at coordinate (0,0) will be the value of the first defect detection image's defect detection signal value at coordinate (0,0). The value of element in the pixel defect feature vector at coordinate (0,0) will be the value of the second defect detection image's defect detection signal value at coordinate (0,0). Likewise, as a further example, the value of element in the pixel defect feature vector at coordinate (2,4) will be the value of the third defect detection image's defect detection signal value at coordinate (2,4).

Over time images of the inspected object are collected and stored to create an image training set that includes training images. For example, a plurality of fused inspection images for a certain vehicle model and color may be collected as training images for that vehicle model and color to build an image training set for that vehicle model and color. The images in this image training set may be examined by a human or machine to identify which images and which pixels have defects, and this information mapping a pixel to a known defect location becomes known image defect locations when associated to the defective pixels stored in the image training set.

The invention uses a pattern classifier, known as a pixel defect pattern classifier, to input the pixel defect feature vector calculated for an inspection pixel and then the pattern classifier outputs a final classification result used to indicate that a pixel has a defect or does not have a defect. There are many pattern classifiers available that are suitable for the purpose of inputting a feature vector having more than two elements and then outputting a classification decision. Classifiers that are good for this application include the Bayes classifier, or sampling spiking neural networks. Other suitable classifiers include the probabilistic neural network, the K-nearest neighbor's classifier, and the support vector machine classifier. Any classifier that can be trained using a set of known input vectors and a set of desired output is suitable, and many pattern classification books and papers are available.

In one embodiment, the pattern classifier is a naive Bayes classifier, and the input vectors are adjusted by a threshold to have values of zero or one depending on how correlated the signal is to a defect. In other cases, the input vector elements may need to be scaled, or hamming encoded to be suitable inputs to the classifier. For example, non-binary values must be hamming encoded to be valid inputs to a sampling spiking neural network.

The pattern classifier is trained using the image training set. A subset of pixels from each image are converted to training pixel defect feature vectors. Typically, this subset of pixels are only those pixels that are over a vehicle surface being inspected. The training pixel defect vector is the training input to the pattern classifier, and the known image defect locations are used as training outputs. After the pattern classifier has been trained it may be used for inspection. An input pixel is taken from an image having pixels that need to be classified for defects. An inspection pixel defect vector is created from the input pixel and input to the classifier. The output of the classifier indicates if the input pixel is likely to have a defect on a surface underneath the pixel. Some classifiers may continue to be trained using a previous window of historical data even as they are used for inspection. Continued training helps the classifier adjust to small changes in the inspection process and maintain accuracy.

The pixel defect feature vector may also be supplemented with metadata about the pixel, including but not limited to numbers that encode the expected color of the vehicle, numbers that encode the pixel's proximity to an edge of the inspected in the camera image, and numbers that encode the expected light intensity of the surface.

For a complete inspection system, it is convenient to have a three dimensional model of inspected surfaces only. When a three dimensional model of the inspected object is available in a standard graphics format such as STL format, masks are defined to identify regions that are not inspected surfaces on the object. Several perspective views of the model are projected into two dimensional space to create a set of images that show different views of the same object. Regions are drawn to mark all of the non-inspected regions on each image. Finally, only surfaces of the original three dimensional model that are both in one of the perspective views of the original model and also never covered by a mask will be kept. The resulting three dimensional object contains only the inspected surface. This three dimensional model can then be used to generate mask files for different camera views and it can be used to calculate inspection coverage and surface area.

Simulation is used to create a map that converts the two dimensional pixel coordinate of a camera image to a three dimensional world coordinate of the inspected object. Assuming that the camera position in world three dimensional coordinates is known, the inspected object is positioned in simulated world coordinates just like an object will be positioned in real world coordinates during inspection. Likewise, the simulated camera is positioned where it is expected to be. Using computer three dimensional simulation methods including ray tracing, the camera's view of the object is simulated. The light source positions are also simulated, as is the motion of the light portico. The lights movement may be simulated so that simulated camera snap images occur when the light is at an expected light source location. The entire scanning sequence may be simulated to generate simulated snap images and simulated fused inspection images. In the simulated environment, the surface of the object under a simulated camera position is known, so the mapping of a camera pixel to the three dimensional object surface can be generated. Additionally, at the end of simulation, the inspection coverage of the surface of the object may be calculated by calculating surface area under each pixel and examining if light was ever reflected directly from the surface to the camera lens for any of the simulated snap images.

Multiple cameras from different viewing angles can be simulated. Simulation can be sped up using cloud computing resources. At the end of simulation, the results from all cameras can be combined to calculate overall coverage of surfaces of the inspected object. Simulation can be used to test camera placement and test adjustments to camera placements until optimal coverage can be attained.

Light sources may emit different intensities of light due to variations in age and manufacturing. The simulator can be used to match a light source with a pixel on a camera image. For example, simulation can identify which light source reflects from the surface into a given camera pixel. This information can be used to measure the intensity of a light source from a set of pixels that reflect only that light source. This intensity measurement may be used to adjust the intensity of the light source for a given color or a given type of test. Additionally, this intensity information can be a parameter input to an image transformation that is designed to level out the variations in light intensity in an image that can be attributed to different light sources being reflected from different locations on the vehicle.

When using a color camera having a Bayer pattern, color detection and color inspection may be achieved concurrent with surface inspection. A fused image that includes the view of a color calibration plate having known RGB values will be captured during the normal operation of the system. Typically, the color calibration plate is located on the object surface. The known cells of the color correction plate are located in the image and a color adjustment algorithm is used to color correct the image so all camera's in the system are consistently color corrected. Once all cameras are color corrected, the statistics of the color of various object surfaces, such as the mean and standard deviation, can be learned and deviations from the expected range of colors can be detected.

The location and orientation of the camera in three dimensional space must be known very precisely for simulation and two dimensional to three dimensional mapping to be effective. A calibration plate may be used using well known calibration techniques to learn the camera position and distortion characteristics. In one technique available through theOpenCV library many images of a checkerboard are taken from different positions and angles to produce camera transform matrices and to locate the camera in space relative to the calibration plate. To locate the position of the calibration plate in world coordinates, a laser distance range finder is mounted on a tripod. The tripod is located at a known world coordinate and three distances from the laser measurement tool to points on the calibration plate are measured. The tripod is moved to a different known world location and the three points are also measured. These measurements are used to triangulate the exact position of the plate.

In another embodiment of this invention, images may be transformed to detect where the surface of the inspected object is located under a pixel. Instead of detecting a defect, the algorithms detect and classify if the object is under a camera pixel. Problems and nonstandard gaps on the object's surface can then be identified when the objects location doesn't match expected object location pixels. Inspection for defects, color, and nonstandard gaps may be inspected in isolation or in conjunction.

Obviously, many modifications and variations of the present invention are possible in light of the above teachings and may be practiced otherwise than as specifically described while within the scope of the appended claims. In addition, the reference numerals in the claims are merely for convenience and are not to be read in any way as limiting.

ELEMENT LIST

| Element Symbol | Element Name |
|---|---|
| 20 | inspected object |
| 22 | light source |
| 24 | inspection camera |
| 26 | inspection location |
| 28 | camera location |
| 30 | light source locations |
| 32 | known image defect locations |
| 34 | snap images |
| 36 | pixels |
| 38 | fused inspection image |
| 40 | first defect detection image |
| 42 | second defect detection image |
| 44 | third defect detection image |
| 46 | training images |
| 48 | first defect detection signal value |
| 50 | second defect detection signal value |
| 52 | third defect detection signal value |
| 54 | first sequence of defect image transformations |
| 56 | second sequence of defect image transformations |
| 58 | third sequence of defect image transformations |
| 60 | pixel defect feature vector |
| 62 | image training set |
| 64 | inspection pixel |
| 66 | common pixel coordinate system |
| 68 | input pixel |
| 70 | inspection pixel defect feature vector |
| 72 | light source path |
| 74 | pixel defect pattern classifier |
| 76 | training pixel defect feature vectors |

What is claimed is:

1. A method for identifying defects on specular surfaces including;
positioning an inspected object (20) at a predetermined inspection location (26), positioning an inspection camera (24) at a fixed camera location (28), moving a light source (22) along a light source path (72) consisting of a plurality of light source locations (30),
acquiring a plurality of inspection snap images (34) from said inspection camera (24) when said light source (22) is located at said light source locations (30),
creating a fused inspection image (38) by combining said inspection snap images (34),
creating a first defect detection image (40) applying a first sequence of defect image transformations (54) to said fused inspection image (38),
creating a second defect detection image (42) by applying a second sequence of defect image transformations (56) to said fused inspection image (38),
creating a third defect detection image (44) by applying a third sequence of defect image transformations (58) to said fused inspection image (38),
organizing said images (34, 38, 40, 42, 44, 46) into pixels (36) using a common pixel coordinate system (66),
assigning a first defect detection signal value (48) to each of said pixels (36) in said first defect detection image (40),
assigning a second defect detection signal value (50) to each of said pixels (36) in said second defect detection image (42),
assigning a third defect detection signal value (52) to each of said pixels (36) in said third defect detection image (44),
and characterized by,
creating a pixel defect feature vector (60) for each of said pixels (36) in said defect detection images (40, 42, 44) comprising said first, second, and third defect detection signal values (48, 50, 52),
creating an image training set (62) consisting of training images (46) from a plurality of said fused inspection images (38) acquired from a plurality of said inspected objects (20),
associating a list of known image defect locations (32) with each of said training images (46) in said image training set (62),
generating training pixel defect feature vectors (76) for each of said training images (46) in said image training set (62) by creating said pixel defect feature vector (60) for each of said pixels (36) in said training images (46),
training a pixel defect pattern classifier (74) to calculate the probability of a defect at an input pixel (68) using said training pixel defect feature vectors (76) as training inputs and said known image defect locations (32) as training outputs,
generating an inspection pixel defect feature vector (70) at an inspection pixel (64) on said fused inspection image (38) by generating said pixel defect feature vector (60) at said inspection pixel (64),
identifying if said inspection pixel (64) is defective from the output of said pixel defect pattern classifier (74) by inputting said inspection pixel defect feature vector (70).
